(19) United States
(12) Patent Application Publication
(10) Pub. No.: US 2009/0252367 A1
(43) Pub. Date: Oct. 8, 2009

(54) Ear Phone/Bud Lanyard

(76) Inventor: John A. Benkovich, III, Chester, MD (US)

Correspondence Address: NYDEGGER & ASSOCIATES, 348 OLIVE STREET, SAN DIEGO, CA, 92103, US

(21) Appl. No.: 12/418,480

(22) Filed: Apr. 3, 2009

Related U.S. Application Data
(60) Provisional application No. 61/042,906, filed on Apr. 7, 2008.

(51) Int. Cl. H04R 25/00

(52) U.S. Cl. 381/380; 381/381

(57) ABSTRACT

An earphone system includes an audio device that is connected via an audio chord with at least one ear-bud Also, the system includes a lanyard that is attached to the chord at a distance “L” from the ear-bud In particular, the lanyard is hung on the ear of a user to position the ear-bud at a distance “d” from the point where the lanyard is connected to the chord Importantly, the distance “L” is adjustable, and the distance “d” is less than the distance “L”

This application claims the benefit of U.S. Provisional Patent Application Ser. No. 61/042,906, filed Apr. 7, 2008.

### FIELD OF THE INVENTION

The present invention pertains generally to an earphone system for a portable audio device. More particularly, the present invention pertains to a support means that facilitates the operation of a portable audio (listening) device during its use. The present invention is particularly, but not exclusively, useful as an earphone system that incorporates a lanyard into its support means for diverting forces from the ear-bud of the earphone system that might otherwise dislodge the ear-bud from the external auditory canal of a user.

### BACKGROUND OF THE INVENTION

Portable audio (listening) devices typically include a headset or a pair of ear-buds for the hearing aspect of their audio functions. However, when ear-buds are used, as opposed to a headset, there is a greater possibility they may somehow be dislodged from the ear, and thereby cause an unwanted disruption of the audio signal. On the other hand, there are many conceivable situations wherein it may be desirable to temporarily remove an ear-bud from the ear. In any event, it is desirable to have control over ear-bud placement. And, this will be so regardless whether it is for control in maintaining ear-bud placement in an ear, or for maintaining easy accessibility to the ear-bud for subsequent replacement in the ear.

In light of the above, it is an object of the present invention to provide an earphone system that effectively maintains the placement of an ear-bud in the ear of a user during operational use of the earphone system. Another object of the present invention is to provide an earphone system that provides easy accessibility to an ear-bud for its replacement in the ear after it has been removed from the ear. Still another object of the present invention is to provide an earphone system that is easy to use, is simple to manufacture and is comparatively cost effective.

### SUMMARY OF THE INVENTION

In accordance with the present invention, a system is provided to operationally stabilize the ear-bud of a portable audio device in the ear of a user, while the audio system is being used. More specifically, the system facilitates holding the ear-bud, in position, in the auditory canal of the user. For this purpose, the system includes a lanyard that hangs from an ear of the user, and is fixedly attached to the chord that interconnects the ear-bud with an audio (listening) device. Specifically, the lanyard is attached to a point on the chord so that, in use, the chord is held slack between the attachment point and the ear-bud. The intended consequence here is to prevent an accidental or inadvertent force on the chord from removing the ear-bud from its position in the auditory canal. Instead, a reaction to the force is transferred from the ear-bud itself, to the ear of the user by the lanyard.

Structurally, the system of the present invention envisions an audio assembly with a device that will be listened to by the user, such as a radio, an ipode, or a CD player. It also includes an ear-bud for listening to the audio device, and the chord that connects the ear-bud to the audio device. As indicated above, in addition to this audio assembly the system includes a lanyard.

For the present invention, the lanyard is preferably a flexible strap that can be hung over the ear of a user. Also included is a connector that is used to fixedly attach the lanyard to the chord of the audio assembly. As envisioned for the present invention, the connector can either be part of the lanyard and selectively attached to the chord, or the lanyard and connector can be integrated as part of the chord. In either case, the connector is used to attach the lanyard to the chord at an attachment point that is at a selected distance “L” along the chord from the ear-bud. As intended for the present invention the distance “L” can be adjusted to suit the user. Further, it is important that when the lanyard hangs from the ear, and while the ear-bud is in its position in the external auditory canal of the user, the connector (i.e. attachment point) is at a distance “d” from the ear-bud. Most importantly, in this arrangement, the distance “d” must remain less than the distance “L”. As mentioned above, such a configuration will maintain slack in the chord that helps prevent a force on the chord from removing the ear-bud from the ear of the user.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of an earphone system in accordance with the present invention;

FIG. 2A is an elevation view of an ear of a user with the earphone system shown in an operational configuration; and

FIG. 2B is a view of the earphone system as shown in FIG. 2A in an alternative configuration.

### DESCRIPTION OF THE PREFERRED EMBODIMENTS

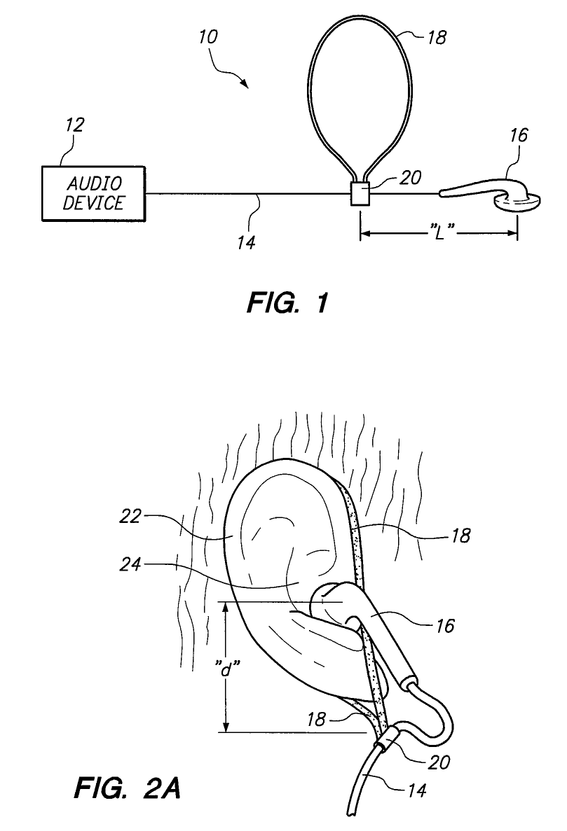

Referring initially to FIG. 1, an earphone system in accordance with the present invention is shown and is generally designated 10. As shown, the system 10 includes an audio device 12 that is connected via an audio chord 14 to an ear-bud 16. As envisioned for the system 10 of the present invention, the audio device 12 can be any type listening device that is commercially available, such as a radio, an ipode, or a CD player. Further, although only one ear-bud 16 is shown, it will be appreciated that the system 10 can include a plurality of ear-buds 16.

FIG. 1 also shows that the system 10 includes a lanyard 18 that is connected to the audio chord 14 by a connector 20. For purposes of the present invention, the connector 20 can have any of several configurations. For one, the connector 20 can be integrated with the chord 14, and then selectively attached to the lanyard 18. On the other hand, the connector 20 can be part of the lanyard 18 and be configured as a clamp that attaches onto the audio chord 14. In any event, the connector 20 is somehow fixedly attached to the audio chord 14. Importantly, the connector 20 is attached to the audio chord 14 at a location that positions the connector 20 at a distance “L” from the ear-bud 16. Preferably, the connector 20 can be selectively located on the audio chord 14 in a manner that will allow a user to adjust the distance “L” for his/her comfort.

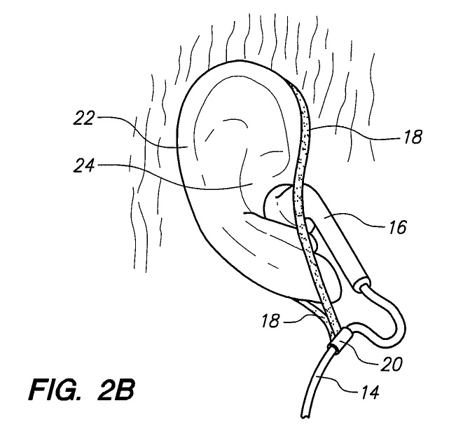

Referring now to FIG. 2A, it will be seen that, when in use, the lanyard 18 is draped over an ear 22 of a user, and the ear-bud 16 is positioned in the external auditory canal 24 of the user's ear 22. It will be appreciated, however, that the ear-bud 16 can be removed from the auditory canal 24 while the lanyard 18 remains draped over the ear 22. If so, the ear-bud 16 is conveniently maintained in the vicinity of the ear 22 for easy replacement in the auditory canal 24.

A salient aspect of the system 10 of the present invention is that when the lanyard 18 and ear-bud 16 are positioned as shown in FIG. 2A, they are at a distance “d” from one another. Importantly, the distance “d” is less than the distance “L” mentioned above. The consequence of this is that the audio chord 14 is made slack between the ear-bud 16 and the connector 20. Accordingly, external forces that may be exerted against the audio chord 14 between the connector 20 and the audio device 12 will be effectively diverted from the ear-bud 16. Instead, their effect is transferred via the lanyard 18 to the ear 22. The benefit of this is that these forces will not then cause the ear-bud 16 to be removed from or loosened in the auditory canal 24 and, thus, will not disrupt operation of the system 10.

For an operation of the system 10, the lanyard 18 is fixedly attached to the audio chord 14 at a location that is a distance “L” from the ear-bud 16. As noted above, this distance “L” can be adjusted to suit the particular user. The lanyard 18 is then draped over an ear 22, and the ear-bud 16 is placed in the external auditory canal 24 of the user, substantially as shown in FIG. 2A. Alternatively, the lanyard 18 can be draped over the ear 22 as well as the ear-bud 16 as shown in FIG. 2B. In either case, it is important that the distance “d” be less than the distance “L” in order to provide slack in the audio chord 14 for the reasons mentioned above. With the lanyard 18 and the ear-bud 16 positioned as just disclosed, the audio device 12 can be turned on for transmitting sound through the ear-bud 16 to the user. As also mentioned above, it is possible for the user to temporarily remove the ear-bud 16 from the ear 22, and then subsequently replace the ear-bud 16 if desired.

While the particular Ear Phone/Bud Lanyard as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An earphone system which comprises:
a chord having a first end and a second end;
an ear-bud connected to the first end of the chord;
an audio device connected to the second end of the chord; and
a lanyard for hanging on an ear of a user, the lanyard being attached to the chord at a point located a distance “L” along the chord from the ear-bud, to maintain the ear-bud at a distance “d” from the point when the lanyard hangs from the ear and the ear-bud is placed in the auditory canal of the user, wherein “d” is less than “L”.

2. A system as recited in claim 1 further comprising a connector for attaching the lanyard to the chord.

3. A system as recited in claim 2 wherein the connector is a clamp.

4. A system as recited in claim 2 wherein the connector is attached to the chord and is selectively engaged with the lanyard to fixedly attach the lanyard to the chord.

5. A system as recited in claim 2 wherein the connector is attached to the lanyard and is selectively engaged with the chord to fixedly attach the lanyard to the chord.

6. A system as recited in claim 1 wherein the lanyard is a flexible strap.

7. A system as recited in claim 6 wherein the lanyard is substantially inelastic.

8. A method for implementing an audio system which comprises the steps of:
presenting an audio assembly which includes a chord having a first end and a second end, an ear-bud connected to the first end of the chord, and an audio device connected to the second end of the chord;
providing a lanyard for hanging on an ear of a user; and
attaching the lanyard to the chord at a point located a distance “L” along the chord from the ear-bud, to maintain the ear-bud at a distance “d” from the point when the lanyard hangs from the ear and the ear-bud is placed in the auditory canal of the user, wherein “d” is less than “L”.

9. A method as recited in claim 8 wherein the attaching step is accomplished by selectively clamping the lanyard at the point on the chord.

10. A method as recited in claim 8 wherein the attaching step is accomplished by integrating the lanyard with the chord at the point on the chord.

11. A method as recited in claim 8 wherein the lanyard is a flexible strap.

12. A method as recited in claim 11 wherein the lanyard is substantially inelastic.

13. A method as recited in claim 11 further comprising the step of adjusting the distance “L” to suit the user.

14. A system for maintaining an ear-bud in position in the auditory canal of a user, wherein the ear-bud is connected to a chord, the system comprising:
a lanyard for hanging on an ear of the user; and
a means for fixedly attaching the lanyard to a point on the chord to maintain slack between the point and the ear-bud when the lanyard hangs from the ear and the ear-bud is placed in the auditory canal of the user.

15. A system as recited in claim 14 wherein the lanyard is attached to the chord at a point located a distance “L” along the chord from the ear-bud, to maintain the ear-bud at a distance “d” from the point when the lanyard hangs from the ear and the ear-bud is placed in the auditory canal of the user, wherein “d” is less than “L”.

16. A system as recited in claim 14 further comprising a connector for attaching the lanyard to the chord.

17. A system as recited in claim 16 wherein the connector is a clamp.

18. A system as recited in claim 16 wherein the connector is attached to the chord and is selectively engaged with the lanyard to fixedly attach the lanyard to the chord.

19. A system as recited in claim 16 wherein the connector is attached to the lanyard and is selectively engaged with the chord to fixedly attach the lanyard to the chord.

20. A system as recited in claim 19 wherein the lanyard is a flexible strap and is substantially inelastic.
